(19) United States
(12) Patent Application Publication
(10) Pub. No.: US 2022/0208017 A1
(43) Pub. Date: Jun. 30, 2022

(54) USER RESEARCH COGNITIVE ASSISTANT FOR MATCHING PERSONAS AND PROVIDING EXPERIENCE INSIGHTS

(71) Applicant: International Business Machines Corporation, Armonk, NY (US)

(72) Inventors: Jennifer M. Hatfield, San Francisco, CA (US); Jill Dhillon, Austin, TX (US); Michael `Bender, Rye Brook, NY (US)

(21) Appl. No.: 17/134,579

(22) Filed: Dec. 28, 2020

(51) Int. Cl. G09B 7/00; G06F 40/35; G06F 16/9032; G06F 16/435

(52) U.S. Cl. CPC G09B 7/00; G06F 16/437; G06F 16/90332; G06F 40/35

(57) ABSTRACT

In an approach for a user research cognitive assistant for matching personas and providing experience insights, a processor receives persona data based on user experience to be modeled. A processor receives interview data associated with research candidates. A processor identifies one or more target candidates based on a match between the persona data and the interview data. A processor monitors the one or more target candidates for the match during an interview. A processor generates an insight with data synthesis identifying an experience level of the one or more target candidates. A processor determines a need of additional recruitment based on the insight and the persona data.

### BACKGROUND

The present disclosure relates generally to the field of cognitive computing and data analysis, and more particularly to a user research cognitive assistant for matching personas and providing experience insights.

Cognitive computing may describe technology platforms that are based on the scientific disciplines of artificial intelligence and signal processing. Cognitive computing may be related to machine learning, reasoning, natural language processing, speech recognition, object recognition, human-computer interaction, dialog and narrative generation, among other technologies. Cognitive computing may refer to new hardware and/or software that helps to improve human decision-making. Cognitive computing can be a type of computing with the goal of more accurate models of how the human mind senses, reasons, and responds to stimulus. Cognitive computing applications may link data analysis and adaptive page displays to adjust content for a particular type of audience. Cognitive computing hardware and applications strive to be more affective and more influential by design.

### SUMMARY

Aspects of an embodiment of the present disclosure disclose an approach for a user research cognitive assistant for matching personas and providing experience insights. A processor receives persona data based on user experience to be modeled. A processor receives interview data associated with research candidates. A processor identifies one or more target candidates based on a match between the persona data and the interview data. A processor monitors the one or more target candidates for the match during an interview. A processor generates an insight with data synthesis identifying an experience level of the one or more target candidates. A processor determines a need of additional recruitment based on the insight and the persona data.

### BRIEF DESCRIPTION OF THE DRAWINGS

FIG. 1 is a functional block diagram illustrating a user research cognitive assistant environment, in accordance with an embodiment of the present disclosure.

FIG. 2 is a flowchart depicting operational steps of a cognitive engine within a computing device of FIG. 1, in accordance with an embodiment of the present disclosure.

FIG. 3 is a block diagram of components of the computing device of FIG. 1, in accordance with an embodiment of the present disclosure.

### DETAILED DESCRIPTION

The present disclosure is directed to systems and methods for a user research cognitive assistant for matching personas and providing experience insights.

Embodiments of the present disclosure recognize a need for identifying if a candidate is a fit for personas based on user experience. A persona, for example, may refer to a role that has been developed based on user experience for seeking for fit candidates. A persona may be other suitable personas developed based on user experience for seeking for fit candidates. For example, many user researchers may be a team conducting a large variety of interview tasks with many candidates at once. An important task is to recruit and interview a fit candidate. Embodiments of the present disclosure recognize that it can be difficult for a user researcher to know whether a candidate is a right person based on the personas developed. Embodiments of the present disclosure disclose providing an additional level of insights into an experience level of the interviewees. Embodiments of the present disclosure disclose enabling a researcher to optimize time and resources while assuring targeted research results. Embodiments of the present disclosure disclose systems and methods of analyzing user research interview persona data with screener criteria, and scanning user research candidate resumes to determine if a user interviewed is a match with the persona developed. Embodiments of the present disclosure disclose identifying, based on interview responses, whether a research candidate is a right person for the role being researched. Embodiments of the present disclosure disclose indicating an overall confidence level that a research candidate is mapped to the correct persona to answer the questions. Embodiments of the present disclosure disclose assigning a confidence level based on the responses of the interviewees and roles. Embodiments of the present disclosure disclose monitoring during the interviews an interviewed user is a match to a persona developed. Embodiments of the present disclosure disclose analyzing patterns from responses and behavior of candidates to evolve a persona to an experience-based level.

Embodiments of the present disclosure disclose supporting a user research persona matching and identification of the research candidate's experience type to ensure proper coverage and mapping of interviews. Embodiments of the present disclosure disclose scanning prospective interviewees based on a user research screening survey. Embodiments of the present disclosure disclose determining sentiment and match in a dialogue from interviews. Embodiments of the present disclosure disclose identifying whether a user is a persona match and assigning a confidence level. Embodiments of the present disclosure disclose communicating to cognitive computing a transcript and determining patterns that appear in data related to interview sentiment analysis, topics, and discussions. Embodiments of the present disclosure disclose crossing link and reference interview subjects by persona elements, for example, roles, needs, influencers, pain points, and goals. Embodiments of the present disclosure disclose compiling recognition samples of common and unique patterns to a user group. Embodiments of the present disclosure disclose a cognitive analysis prior to and post interview enabling align of resources and a proper coverage for a user experience research phase between interviewees and personas. Embodiments of the present disclosure disclose solving a problem of a basic research by automating a persona matching process to the correct research candidates and providing experience level insights based on the interview. Embodiments of the present disclosure disclose aiding a user researcher with more in-depth findings and insight analysis and finding a more targeted user group potentially at a greater speed.

Embodiments of the present disclosure disclose identifying personas based on user experience to be modeled. Embodiments of the present disclosure disclose collecting job role descriptions based on potential interviewees. Embodiments of the present disclosure disclose identifying a target user group based on profile inputs from interview and related data corpus. Embodiments of the present disclosure disclose transcribing multiple voices to text from research recordings. Embodiments of the present disclosure disclose synthesizing research data inputs through cognitive analysis and extracting common themes to determine and validate a right pool of interviewees. Embodiments of the present disclosure disclose identifying and extracting themes based upon duplicity, repetition of thoughts, topics, feelings, and events between users and user groups. Embodiments of the present disclosure disclose creating hierarchical categorization and labels which elements may be most common to least common themes. Embodiments of the present disclosure disclose generating insights with synthesis of data, for example, insight parameters that can be customized or derived from project background, historical information, trends analysis. Embodiments of the present disclosure disclose using predictive analytics of what research needs to happen due to gaps found in historical data and existing/upcoming work.

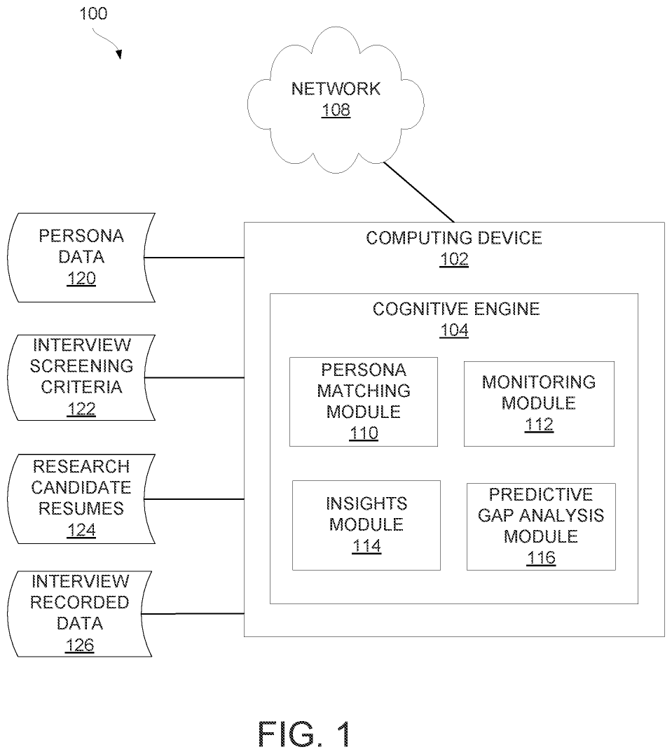

The present disclosure will now be described in detail with reference to the Figures. FIG. 1 is a functional block diagram illustrating a user research cognitive assistant environment, generally designated 100, in accordance with an embodiment of the present disclosure.

In the depicted embodiment, user research cognitive assistant environment 100 includes computing device 102, persona data 120, interview screening criteria 122, research candidate resumes 124, interview recorded data 126, and network 108. In the depicted embodiment, persona data 120, interview screening criteria 122, research candidate resumes 124, interview recorded data 126 are located and stored externally from computing device 102. In other embodiments, persona data 120, interview screening criteria 122, research candidate resumes 124, interview recorded data 126 may be located on computing device 102. In an example, persona data 120, interview screening criteria 122, research candidate resumes 124, interview recorded data 126 may be accessed directly from computing device 102. In another example, persona data 120, interview screening criteria 122, research candidate resumes 124, interview recorded data 126 may be accessed through a communication network such as network 108. In an example, persona data 120 may refer to roles or other suitable personas for research candidates. Persona data 120 may refer to views of individuals' personality, social roles that people adopt, or characters developed based on user experience for seeking for fit candidates for research, job, or other purposes. Persona data 120 may be other suitable personas developed based on user experience for seeking for fit candidates for research, job, or other purposes. Interview screening criteria 122 may be surveys and job role descriptions. The surveys and job role descriptions may be screened prior to the interview to identify if a user (e.g., a research candidate person) is a primary match or super user for the persona/role being interviewed. Research candidate resumes 124 may be scanned to determine if a user (e.g., a research candidate) interviewed is a match with persona data 120. Interview recorded data 126 may include data associated to events recorded using cameras, audio feeds, video feeds, and other suitable recorded interview data. Interview recorded data 126 may be transcribed to text.

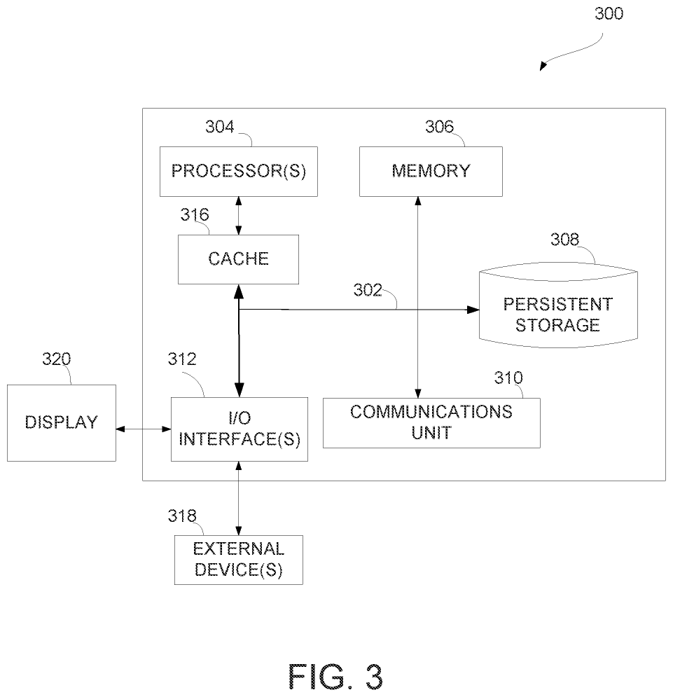

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to cognitive engine 104 and network 108 and is capable of processing program instructions and executing cognitive engine 104, in accordance with an embodiment of the present disclosure. Computing device 102 may include internal and external hardware components, as depicted and described in further detail with respect to FIG. 3.

Further, in the depicted embodiment, computing device 102 includes cognitive engine 104. In the depicted embodiment, cognitive engine 104 is located on computing device 102. However, in other embodiments, cognitive engine 104 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102 and cognitive engine 104, in accordance with a desired embodiment of the disclosure.

In one or more embodiments, cognitive engine 104 is configured to receive persona data 120 based on user experience to be modeled. Persona data 120 may refer to roles or other suitable personas for research candidates. Persona data 120 may refer to views of individuals' personality, social roles that people adopt, or characters developed based on user experience for seeking for fit candidates for research, job, or other purposes. Persona data 120 may be other suitable personas developed based on user experience for seeking for fit candidates for research, job, or other purposes. Cognitive engine 104 may collect job role descriptions (e.g., role, experience level, and impact level) based on potential interviewees related to persona data 120. Cognitive engine 104 may identify primary and secondary personas based on the user experience. Cognitive engine 104 may apply persona criteria to research recruitments and interviews. Cognitive engine 104 may identify experience levels of users interviewed.

In one or more embodiments, cognitive engine 104 is configured to receive interview data associated with research candidates. In an example, interview data may include interview screening criteria 122, research candidate resumes 124, and interview recorded data 126. For example, interview screening criteria 122 may be surveys and job role descriptions. Cognitive engine 104 may screen the surveys and job role descriptions prior to an interview to identify if a user (e.g., a research candidate) is a primary match or super user for the persona/role being interviewed. Cognitive engine 104 may make a recommendation if the match is also impacted but perform in a secondary or tertiary role. Cognitive engine 104 may scan prospective interviewees based on user research screening survey. Cognitive engine 104 may listen and/or scan recruitment entry criteria (e.g., interview screening criteria 122 and research candidate resumes 124). Cognitive engine 104 may determine sentiment and match in the dialogue from interviews. Interview recorded data 126 may include data associated to events recorded using cameras, audio feeds, video feeds, and other suitable recorded data. Cognitive engine 104 may transcribe interview recorded data 126 to text. Cognitive engine 104 may analyze persona data 120 (e.g., for user research interview) with interview screening criteria 122. Cognitive engine 104 may scan research candidate resumes 124 to determine if a user (e.g., a research candidate) interviewed is a match with the persona. In an example, when a user researcher has been asked to conduct a few interview sessions, the user researcher may develop several personas and will need to recruit the right participants. Cognitive engine 104 may scan research candidate resumes 124 for match criteria prior to the interviews to aid in the recruiting of the right individuals. Cognitive engine 104 may provide a confidence rating for each participant and may provide interview recruitment choices for the user researcher. Cognitive engine 104 may automate a persona matching process to proper research candidates and may provide experience level insights based on the interviews.

In one or more embodiments, cognitive engine 104 is configured to identify one or more target candidates based on a match between persona data 120 and the interview data (e.g., interview screening criteria 122, research candidate resumes 124, and interview recorded data 126). Cognitive engine 104 may identify whether a user (e.g., a research candidate) is a persona match and may assign a confidence level to the user. Cognitive engine 104 may identify a target user group based on profile inputs from interview and related data corpus. For example, cognitive engine 104 may construct a persona input profile based on an input from the interview data. Cognitive engine 104 may construct a persona inputs profile based on inputs from the interview and related data corpus (e.g., interview screening criteria 122, research candidate resumes 124, and interview recorded data 126). Cognitive engine 104 may generate a recommended persona covering a key data point. Cognitive engine 104 may auto-generate recommended persona(s) covering the key data points. Cognitive engine 104 may identify a coverage gap between persona data 120 and the interview data. Cognitive engine 104 may support user research persona matching and identification of the research candidate's experience type to ensure proper coverage and mapping of interviews. Cognitive engine 104 may identify if a user being interviewed is a fit for a persona. Cognitive engine 104 may provide an additional level of insight into the experience level of the interviewee. As a result, cognitive engine 104 may enable a user researcher to optimize time and resources while assuring a targeted research result. Cognitive engine 104 may automate the persona matching process to the right research candidates and may provide experience level insights based on the interview. Cognitive engine 104 may aid the user researcher with more in-depth findings and insight analysis and may detect a more targeted user group potentially at a great speed than before. In an example, when a user researcher may discover, during a scanning process of criteria, that many of the prospective interviewees are not a match based on the screening process, cognitive engine 104 may recommend reaching out for additional candidates.

In one or more embodiments, cognitive engine 104 is configured to monitor one or more target candidates for a match between persona data 120 and the interview data during an interview. Cognitive engine 104 may monitor during the interview to confirm the interviewed candidate is a match to the persona. Cognitive engine 104 may listen during the interviews to identify experience level of and impact to the target candidates. Cognitive engine 104 may determine sentiment of the target candidates during the interview with agreement levels and competitive responses. Cognitive engine 104 may have an option for recording interviews with the target candidates. The interviewees (e.g., the target candidates) can disable this feature or have to opt in to have the interview to be recorded. The interviewees are in control of what type of information is going to be collected and aware of how that information is going to be used. Cognitive engine 104 may transcribe in-person recordings or real time events to text from the recorded interviews. Cognitive engine 104 may store interview recorded data 126. Cognitive engine 104 may compare multiple events for analysis. Cognitive engine 104 may determine user sentiment and may capture the sentiment as a data point. Based on interview responses, cognitive engine 104 may identify whether a target candidate is a fit candidate based on the persona developed. Cognitive engine 104 may indicate an overall confidence level that the target candidate may be mapped to an associated persona to answer the questions. Cognitive engine 104 may assign a confidence level to the responses of the interviewee and role. Cognitive engine 104 may analyze the transcripts and may determine patterns that appear in the data between interview sentiment analysis, topics (including tagged points and opportunities), and discussions. Cognitive engine 104 may cross link and reference interview subjects by persona elements, for example, roles, needs, influencers, pain points, and goals.

In one or more embodiments, cognitive engine 104 is configured to generate an insight with data synthesis identifying experience level of one or more target candidates. Cognitive engine 104 may synthesize research data inputs through cognitive analysis. Cognitive engine 104 may extract common themes to determine and validate a right pool of interviewees has been identified. Cognitive engine 104 may synthesize research data inputs through cognitive analysis and extract common themes to determine and validate the right pool of interviewees has been identified. Cognitive engine 104 may apply natural language processing to cover personas based on conversations. Cognitive engine 104 may use sentiment analysis to cover if the research candidates are engaged. Cognitive engine 104 may determine through the natural language processing consistency of answers by individual research candidates. In an example, an experience level may include early-adopter, novice, resistor, and other suitable level. Cognitive engine 104 may identify a ‘yes’ person (someone who is always agreeable) and a competitor based on their responses. Cognitive engine 104 may synthesize research data inputs through cognitive analysis and extract common themes to determine and validate the right pool of interviewees has been identified. Cognitive engine 104 may identify and extract themes based upon duplicity, repetition of thoughts, topics, feelings, and events between users and user groups. Cognitive engine 104 may access data corpus of the transcribed information. Cognitive engine 104 may use cognitive analysis to identify common elements between users and interview participants. Cognitive engine 104 may create hierarchical categorization and label which elements are most common to least common themes. Cognitive engine 104 may generate insights with synthesis of data (e.g., insight parameters that can be customized or derived from project background, historical information, trends analysis). Cognitive engine 104 may provide natural language processing to cover personas based on conversations. Cognitive engine 104 may perform sentiment analysis to cover if an interviewee is engaged. Cognitive engine 104 may determine through natural language processing consistency of answers by an individual candidate. For example, cognitive engine 104 may provide a researcher to identify the experience level of the research candidates. Cognitive engine 104 may listen and understand the interviewees experience level in a job role. Cognitive engine 104 may listen and understand an impact based on the responses of the user to specific questions. Cognitive engine 104 may identify nuances from a candidate, such as if the candidate is too agreeable or holding back in responses. For example, cognitive engine 104 may recognize that the candidate is too agreeable based on finding words from the responses indicating agreeable (e.g., often saying “yes” to almost everything). In another example, cognitive engine 104 may recognize that the candidate is holding back based on finding words from the responses (e.g., often expressing different or competitive arguments and positions). Cognitive engine 104 may provide valuable information gathered as a result of the screening and recommendation process, saving the client time and money, and enabling the project to have the correct qualitative and quantitative data from the interviews to move forward. Cognitive engine 104 may compile sample data of common and unique patterns to a user group. For example, cognitive engine 104 may provide the sample data to a researcher for review and acceptance as is or editing. If the researcher wishes to edit, cognitive engine 104 may provide the data for realignment and training purposes. Cognitive engine 104 may develop a full set of recommendations for a user researcher. For example, cognitive engine 104 may distinguish a user type based on profile data. Cognitive engine 104 may distinguish geographic differences and other noted data in the profile. Cognitive engine 104 may apply contextual analysis when reviewing responses to questions. Cognitive engine 104 may display sentiment scores for all users with an average sentiment score. Cognitive engine 104 may identify common patterns with users by matching themes, similarity in statements, and languages (weighting results for relevancy). Cognitive engine 104 may identify pain points and opportunities. Cognitive engine 104 may identify sentiment during on video or in-person interview. Cognitive engine 104 may apply persona data via a user interface for illustration.

In one or more embodiments, cognitive engine 104 is configured to determine a need of additional recruitment based on generated insights and persona data 120. Cognitive engine 104 may use predictive analytics to determine if additional recruitment needs to take place based on generated insights and requirements of the primary and secondary personas. Cognitive engine 104 may use predictive analytics of what research needs to happen due to gaps found in historical data and existing and upcoming work. Cognitive engine 104 may supplement an interviewee list based on non-covered personas. Cognitive engine 104 may supplement an interview list based on interviewees of covered personas with a low confidence level. Cognitive engine 104 may look at patterns from responses and behavior of users to evolve the persona to an experience-based level. Cognitive engine 104 may, prior to and post interview, enable align of resources and a proper coverage for a user experience research phase between interviewees and personas.

In the depicted embodiment, cognitive engine 104 includes persona matching module 110, monitoring module 112, insights module 114, and predictive gap analysis module 116. In the depicted embodiment, persona matching module 110, monitoring module 112, insights module 114, and predictive gap analysis module 116 are located on computing device 102. However, in other embodiments, persona matching module 110, monitoring module 112, insights module 114, and predictive gap analysis module 116 may be located externally and accessed through a communication network such as network 108.

In one or more embodiments, persona matching module 110 is configured to identify one or more target candidates based on a match between persona data 120 and the interview data (e.g., interview screening criteria 122, research candidate resumes 124, and interview recorded data 126). Persona matching module 110 may identify whether a user (e.g., a research candidate) is a persona match and may assign a confidence level to the user. Persona matching module 110 may identify a target user group based on profile inputs from interview and related data corpus. For example, persona matching module 110 may construct a persona input profile based on an input from the interview data. Persona matching module 110 may construct a persona inputs profile based on inputs from the interview and related data corpus (e.g., interview screening criteria 122, research candidate resumes 124, and interview recorded data 126). Persona matching module 110 may generate a recommended persona covering a key data point. Persona matching module 110 may auto-generate recommended persona(s) covering the key data points. Persona matching module 110 may identify a coverage gap between persona data 120 and the interview data. Persona matching module 110 may support user research persona matching and identification of the research candidate's experience type to ensure proper coverage and mapping of interviews. Persona matching module 110 may identify if a user being interviewed is a fit for a persona. Persona matching module 110 may provide an additional level of insight into the experience level of the interviewee. As a result, persona matching module 110 may enable a user researcher to optimize time and resources while assuring a targeted research result. Persona matching module 110 may automate the persona matching process to the right research candidates and may provide experience level insights based on the interview. Persona matching module 110 may aid the user researcher with more in-depth findings and insight analysis and may detect a more targeted user group potentially at a great speed than before. In an example, when a user researcher may discover, during a scanning process of criteria, that many of the prospective interviewees are not a match based on the screening process, persona matching module 110 may recommend reaching out for additional candidates.

In one or more embodiments, monitoring module 112 is configured to monitor one or more target candidates for a match between persona data 120 and the interview data during an interview. Monitoring module 112 may monitor during the interview to confirm the interviewed candidate is a match to the persona. Monitoring module 112 may listen during the interviews to identify experience level of and impact to the target candidates. Monitoring module 112 may determine sentiment of the target candidates during the interview with agreement levels and competitive responses. Monitoring module 112 may have an option for recording interviews with the target candidates. The interviewees (e.g., the target candidates) can disable this feature or have to opt in to have the interview to be recorded. The interviewees are in control of what type of information is going to be collected and aware of how that information is going to be used. Monitoring module 112 may transcribe in-person recordings or real time events to text from the recorded interviews. Monitoring module 112 may store interview recorded data 126. Monitoring module 112 may compare multiple events for analysis. Monitoring module 112 may determine user sentiment and may capture the sentiment as a data point. Based on interview responses, monitoring module 112 may identify whether a target candidate is a fit candidate for the persona being researched or not. Monitoring module 112 may indicate an overall confidence level that the target candidate may be mapped to a correct persona to answer the questions. Monitoring module 112 may assign a confidence level to the responses of the interviewee and role. Monitoring module 112 may analyze the transcripts and may determine patterns that appear in the data between interview sentiment analysis, topics (including tagged points and opportunities), and discussions. Monitoring module 112 may cross link and reference interview subjects by persona elements, for example, roles, demographics, needs, influencers, pain points, and goals.

In one or more embodiments, insights module 114 is configured to generate an insight with data synthesis identifying experience level of one or more target candidates. Insights module 114 may synthesize research data inputs through cognitive analysis. Insights module 114 may extract common themes to determine and validate a right pool of interviewees has been identified. Insights module 114 may synthesize research data inputs through cognitive analysis and extract common themes to determine and validate the right pool of interviewees has been identified. Insights module 114 may apply natural language processing to cover personas based on conversations. Insights module 114 may use sentiment analysis to cover if the research candidates are engaged. Insights module 114 may determine through the natural language processing consistency of answers by individual research candidates. In an example, an experience level may include early-adopter, novice, resistor, and other suitable level. Insights module 114 may identify a ‘yes’ person (someone who is always agreeable) and a competitor based on their responses. Insights module 114 may synthesize research data inputs through cognitive analysis and extract common themes to determine and validate the right pool of interviewees has been identified. Insights module 114 may identify and extract themes based upon duplicity, repetition of thoughts, topics, feelings, and events between users and user groups. Insights module 114 may access data corpus of the transcribed information. Insights module 114 may use cognitive analysis to identify common elements between users and interview participants. Insights module 114 may create hierarchical categorization and label which elements are most common to least common themes. Insights module 114 may generate insights with synthesis of data (e.g., insight parameters that can be customized or derived from project background, historical information, trends analysis). Insights module 114 may provide natural language processing to cover personas based on conversations. Insights module 114 may perform sentiment analysis to cover if an interviewee is engaged. Insights module 114 may determine through natural language processing consistency of answers by an individual candidate. For example, insights module 114 may provide a researcher to identify the experience level of the research candidates. Insights module 114 may listen and understand the interviewees experience level in a job role. Insights module 114 may listen and understand an impact based on the responses of the user to specific questions. Insights module 114 may identify nuances from a candidate, such as if the candidate is too agreeable or holding back in responses. Insights module 114 may provide valuable information gathered as a result of the screening and recommendation process, saving the client time and money, and enabling the project to have the correct qualitative and quantitative data from the interviews to move forward. Insights module 114 may compile sample data of common and unique patterns to a user group. For example, insights module 114 may provide the sample data to a researcher for review and acceptance as is or editing. If the researcher wishes to edit, insights module 114 may provide the data for realignment and training purposes. Insights module 114 may develop a full set of recommendations for a user researcher. For example, insights module 114 may distinguish a user type based on profile data. Insights module 114 may distinguish geographic differences and other noted data in the profile. Insights module 114 may apply contextual analysis when reviewing responses to questions. Insights module 114 may display sentiment scores for all users with an average sentiment score. Insights module 114 may identify common patterns with users by matching themes, similarity in statements, and languages (weighting results for relevancy). Insights module 114 may identify pain points and opportunities. Insights module 114 may identify sentiment during on video or in-person interview. Insights module 114 may apply persona data via a user interface for illustration.

In one or more embodiments, predictive gap analysis module 116 is configured to determine a need of additional recruitment based on generated insights and persona data 120. Predictive gap analysis module 116 may use predictive analytics to determine if additional recruitment needs to take place based on generated insights and requirements of the primary and secondary personas. Predictive gap analysis module 116 may use predictive analytics of what research needs to happen due to gaps found in historical data and existing and upcoming work. Predictive gap analysis module 116 may supplement an interviewee list based on non-covered personas. Predictive gap analysis module 116 may supplement an interview list based on interviewees of covered personas with a low confidence level. Predictive gap analysis module 116 may look at patterns from responses and behavior of users to evolve the persona to an experience-based level. Predictive gap analysis module 116 may, prior to and post interview, enable align of resources and a proper coverage for a user experience research phase between interviewees and personas.

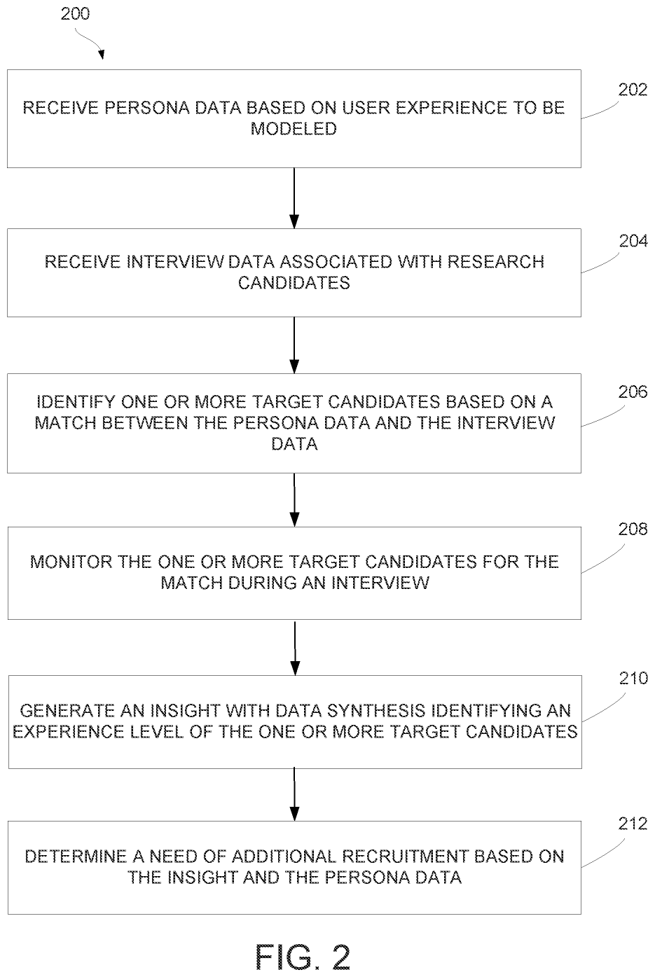

FIG. 2 is a flowchart 200 depicting operational steps of cognitive engine 104 in accordance with an embodiment of the present disclosure.

Cognitive engine 104 operates to receive persona data 120 based on user experience to be modeled. Cognitive engine 104 also operates to receive interview data associated with research candidates. Interview data may include interview screening criteria 122, research candidate resumes 124, and interview recorded data 126. Cognitive engine 104 operates to identify one or more target candidates based on a match between persona data 120 and the interview data. Cognitive engine 104 operates to monitor one or more target candidates for a match between persona data 120 and the interview data during an interview. Cognitive engine 104 operates to generate an insight with data synthesis identifying experience level of one or more target candidates. Cognitive engine 104 operates to determine a need of additional recruitment based on generated insights and persona data 120.

In step 202, cognitive engine 104 receives persona data 120 based on user experience to be modeled. Persona data 120 may refer to roles or other suitable personas for research candidates. Cognitive engine 104 may collect job role descriptions (e.g., role, experience level, and impact level) based on potential interviewees related to persona data 120. Cognitive engine 104 may identify primary and secondary personas based on the user experience. Cognitive engine 104 may apply persona criteria to research recruitments and interviews. Cognitive engine 104 may identify experience levels of users interviewed.

In step 204, cognitive engine 104 receives interview data associated with research candidates. In an example, interview data may include interview screening criteria 122, research candidate resumes 124, and interview recorded data 126. For example, interview screening criteria 122 may be surveys and job role descriptions. Cognitive engine 104 may screen the surveys and job role descriptions prior to an interview to identify if a user (e.g., a research candidate) is a primary match or super user for the persona/role being interviewed. Cognitive engine 104 may make a recommendation if the match is also impacted but perform in a secondary or tertiary role. Cognitive engine 104 may scan prospective interviewees based on user research screening survey. Cognitive engine 104 may listen and/or scan recruitment entry criteria (e.g., interview screening criteria 122 and research candidate resumes 124). Cognitive engine 104 may determine sentiment and match in the dialogue from interviews. Interview recorded data 126 may include data associated to events recorded using cameras, audio feeds, video feeds, and other suitable recorded data. Cognitive engine 104 may transcribe interview recorded data 126 to text. Cognitive engine 104 may analyze persona data 120 (e.g., for user research interview) with interview screening criteria 122. Cognitive engine 104 may scan research candidate resumes 124 to determine if a user (e.g., a research candidate) interviewed is a match with the persona. In an example, when a user researcher has been asked to conduct a few interview sessions, the user researcher may develop several personas and will need to recruit the right participants. Cognitive engine 104 may scan research candidate resumes 124 for match criteria prior to the interviews to aid in the recruiting of the right individuals. Cognitive engine 104 may provide a confidence rating for each participant and may provide interview recruitment choices for the user researcher. Cognitive engine 104 may automate a persona matching process to proper research candidates and may provide experience level insights based on the interviews.

In step 206, cognitive engine 104 identifies one or more target candidates based on a match between persona data 120 and the interview data (e.g., interview screening criteria 122, research candidate resumes 124, and interview recorded data 126). Cognitive engine 104 may identify whether a user (e.g., a research candidate) is a persona match and may assign a confidence level to the user. Cognitive engine 104 may identify a target user group based on profile inputs from interview and related data corpus. For example, cognitive engine 104 may construct a persona input profile based on an input from the interview data. Cognitive engine 104 may construct a persona inputs profile based on inputs from the interview and related data corpus (e.g., interview screening criteria 122, research candidate resumes 124, and interview recorded data 126). Cognitive engine 104 may generate a recommended persona covering a key data point. Cognitive engine 104 may auto-generate recommended persona(s) covering the key data points. Cognitive engine 104 may identify a coverage gap between persona data 120 and the interview data. Cognitive engine 104 may support user research persona matching and identification of the research candidate's experience type to ensure proper coverage and mapping of interviews. Cognitive engine 104 may identify if a user being interviewed is a fit for a persona. Cognitive engine 104 may provide an additional level of insight into the experience level of the interviewee. As a result, cognitive engine 104 may enable a user researcher to optimize time and resources while assuring a targeted research result. Cognitive engine 104 may automate the persona matching process to the right research candidates and may provide experience level insights based on the interview. Cognitive engine 104 may aid the user researcher with more in-depth findings and insight analysis and may detect a more targeted user group potentially at a great speed than before. In an example, when a user researcher may discover, during a scanning process of criteria, that many of the prospective interviewees are not a match based on the screening process, cognitive engine 104 may recommend reaching out for additional candidates.

In step 208, cognitive engine 104 monitors one or more target candidates for a match between persona data 120 and the interview data during an interview. Cognitive engine 104 may monitor during the interview to confirm the interviewed candidate is a match to the persona. Cognitive engine 104 may listen during the interviews to identify experience level of and impact to the target candidates. Cognitive engine 104 may determine sentiment of the target candidates during the interview with agreement levels and competitive responses. Cognitive engine 104 may have an option for recording interviews with the target candidates. The interviewees (e.g., the target candidates) can disable this feature or have to opt in to have the interview to be recorded. The interviewees are in control of what type of information is going to be collected and aware of how that information is going to be used. Cognitive engine 104 may transcribe in-person recordings or real time events to text from the recorded interviews. Cognitive engine 104 may store interview recorded data 126. Cognitive engine 104 may compare multiple events for analysis. Cognitive engine 104 may determine user sentiment and may capture the sentiment as a data point. Based on interview responses, cognitive engine 104 may identify whether a target candidate is a fit candidate for the persona being researched or not. Cognitive engine 104 may indicate an overall confidence level that the target candidate may be mapped to a correct persona to answer the questions. Cognitive engine 104 may assign a confidence level to the responses of the interviewee and role. Cognitive engine 104 may analyze the transcripts and may determine patterns that appear in the data between interview sentiment analysis, topics (including tagged points and opportunities), and discussions. Cognitive engine 104 may cross link and reference interview subjects by persona elements, for example, roles, needs, influencers, pain points, and goals.

In step 210, cognitive engine 104 generates an insight with data synthesis identifying experience level of one or more target candidates. Cognitive engine 104 may synthesize research data inputs through cognitive analysis. Cognitive engine 104 may extract common themes to determine and validate a right pool of interviewees has been identified. Cognitive engine 104 may synthesize research data inputs through cognitive analysis and extract common themes to determine and validate the right pool of interviewees has been identified. Cognitive engine 104 may apply natural language processing to cover personas based on conversations. Cognitive engine 104 may use sentiment analysis to cover if the research candidates are engaged. Cognitive engine 104 may determine through the natural language processing consistency of answers by individual research candidates. In an example, an experience level may include early-adopter, novice, resistor, and other suitable level. Cognitive engine 104 may identify a ‘yes’ person (someone who is always agreeable) and a competitor based on their responses. Cognitive engine 104 may synthesize research data inputs through cognitive analysis and extract common themes to determine and validate the right pool of interviewees has been identified. Cognitive engine 104 may identify and extract themes based upon duplicity, repetition of thoughts, topics, feelings, and events between users and user groups. Cognitive engine 104 may access data corpus of the transcribed information. Cognitive engine 104 may use cognitive analysis to identify common elements between users and interview participants. Cognitive engine 104 may create hierarchical categorization and label which elements are most common to least common themes. Cognitive engine 104 may generate insights with synthesis of data (e.g., insight parameters that can be customized or derived from project background, historical information, trends analysis). Cognitive engine 104 may provide natural language processing to cover personas based on conversations. Cognitive engine 104 may perform sentiment analysis to cover if an interviewee is engaged. Cognitive engine 104 may determine through natural language processing consistency of answers by an individual candidate. For example, cognitive engine 104 may provide a researcher to identify the experience level of the research candidates. Cognitive engine 104 may listen and understand the interviewees experience level in a job role. Cognitive engine 104 may listen and understand an impact based on the responses of the user to specific questions. Cognitive engine 104 may identify nuances from a candidate, such as if the candidate is too agreeable or holding back in responses. Cognitive engine 104 may provide valuable information gathered as a result of the screening and recommendation process, saving the client time and money, and enabling the project to have the correct qualitative and quantitative data from the interviews to move forward. Cognitive engine 104 may compile sample data of common and unique patterns to a user group. For example, cognitive engine 104 may provide the sample data to a researcher for review and acceptance as is or editing. If the researcher wishes to edit, cognitive engine 104 may provide the data for realignment and training purposes. Cognitive engine 104 may develop a full set of recommendations for a user researcher. For example, cognitive engine 104 may distinguish a user type based on profile data. Cognitive engine 104 may distinguish geographic differences and other noted data in the profile. Cognitive engine 104 may apply contextual analysis when reviewing responses to questions. Cognitive engine 104 may display sentiment scores for all users with an average sentiment score. Cognitive engine 104 may identify common patterns with users by matching themes, similarity in statements, and languages (weighting results for relevancy). Cognitive engine 104 may identify pain points and opportunities. Cognitive engine 104 may identify sentiment during on video or in-person interview. Cognitive engine 104 may apply persona data via a user interface for illustration.

In step 212, cognitive engine 104 determines a need of additional recruitment based on generated insights and persona data 120. Cognitive engine 104 may use predictive analytics to determine if additional recruitment needs to take place based on generated insights and requirements of the primary and secondary personas. Cognitive engine 104 may use predictive analytics of what research needs to happen due to gaps found in historical data and existing and upcoming work. Cognitive engine 104 may supplement an interviewee list based on non-covered personas. Cognitive engine 104 may supplement an interview list based on interviewees of covered personas with a low confidence level. Cognitive engine 104 may look at patterns from responses and behavior of users to evolve the persona to an experience-based level. Cognitive engine 104 may, prior to and post interview, enable align of resources and a proper coverage for a user experience research phase between interviewees and personas.

FIG. 3 depicts a block diagram 300 of components of computing device 102 in accordance with an illustrative embodiment of the present disclosure. It should be appreciated that FIG. 3 provides only an illustration of one implementation and does not imply any limitations with regard to the environments in which different embodiments may be implemented. Many modifications to the depicted environment may be made.

Computing device 102 may include communications fabric 302, which provides communications between cache 316, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a crossbar switch.

Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Cognitive engine 104 may be stored in persistent storage 308 and in memory 306 for execution by one or more of the respective computer processors 304 via cache 316. In an embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. Cognitive engine 104 may be downloaded to persistent storage 308 through communications unit 310.

I/O interface(s) 312 allows for input and output of data with other devices that may be connected to computing device 102. For example, I/O interface 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention, e.g., cognitive engine 104 can be stored on such portable computer readable storage media and can be loaded onto persistent storage 308 via I/O interface(s) 312. I/O interface(s) 312 also connect to display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method comprising:
receiving, by one or more processors, persona data based on user experience to be modeled;
receiving, by one or more processors, interview data associated with research candidates;
identifying, by one or more processors, one or more target candidates based on a match between the persona data and the interview data;
monitoring, by one or more processors, the one or more target candidates for the match during an interview;
generating, by one or more processors, an insight with data synthesis identifying an experience level of the one or more target candidates; and
determining, by one or more processors, a need of additional recruitment based on the insight and the persona data.

2. The computer-implemented method of claim 1, wherein identifying the one or more target candidates comprises:
constructing a persona input profile based on an input from the interview data;
generating a recommended persona covering a key data point; and
identifying a coverage gap between the persona data and the interview data.

3. The computer-implemented method of claim 1, further comprising:
synthesizing research data inputs through cognitive analysis; and
extracting common themes to determine and validate a right pool of interviewees has been identified.

4. The computer-implemented method of claim 1, wherein generating the insight comprises:
applying a natural language processing to cover personas from the persona data based on conversations;
using sentiment analysis to cover if the research candidates are engaged; and
determining through a natural language processing consistency of answers by individual research candidates.

5. The computer-implemented method of claim 1, wherein determining the need of additional recruitment comprises:
supplementing a first interviewee list based on non-covered personas from the persona data; and
supplementing a second interviewee list based on interviewees of covered personas from the persona data with a low confidence level.

6. The computer-implemented method of claim 1, wherein the interview data comprises interview screening criteria, research candidate resumes, and recorded interviews with the research candidates.

7. The computer-implemented method of claim 6, further comprising transcribing a recorded interview to text, the recorded interview selected from the group consisting of: an event recorded using a camera, an audio feed, and a video feed.

8. A computer program product comprising:
one or more computer readable storage media, and program instructions collectively stored on the one or more computer readable storage media, the program instructions comprising:
program instructions to receive persona data based on user experience to be modeled;
program instructions to receive interview data associated with research candidates;
program instructions to identify one or more target candidates based on a match between the persona data and the interview data;
program instructions to monitor the one or more target candidates for the match during an interview;
program instructions to generate an insight with data synthesis identifying an experience level of the one or more target candidates; and
program instructions to determine a need of additional recruitment based on the insight and the persona data.

9. The computer program product of claim 8, wherein program instructions to identify the one or more target candidates comprise:
program instructions to construct a persona input profile based on an input from the interview data;
program instructions to generate a recommended persona covering a key data point; and
program instructions to identify a coverage gap between the persona data and the interview data.

10. The computer program product of claim 8, further comprising:
program instructions, stored on the one or more computer-readable storage media, to synthesize research data inputs through cognitive analysis; and
program instructions, stored on the one or more computer-readable storage media, to extract common themes to determine and validate a right pool of interviewees has been identified.

11. The computer program product of claim 8, wherein program instructions to generate the insight comprise:
program instructions to apply a natural language processing to cover personas from the persona data based on conversations;
program instructions to use sentiment analysis to cover if the research candidates are engaged; and
program instructions to determine through a natural language processing consistency of answers by individual research candidates.

12. The computer program product of claim 8, wherein program instructions to determine the need of additional recruitment comprises:
program instructions to supplement a first interviewee list based on non-covered personas from the persona data; and
program instructions to supplement a second interviewee list based on interviewees of covered personas from the persona data with a low confidence level.

13. The computer program product of claim 8, wherein the interview data comprises interview screening criteria, research candidate resumes, and recorded interviews with the research candidates.

14. The computer program product of claim 13, further comprising program instructions to transcribe a recorded interview to text, the recorded interview selected from the group consisting of: an event recorded using a camera, an audio feed, and a video feed.

15. A computer system comprising:
one or more computer processors, one or more computer readable storage media, and program instructions stored on the one or more computer readable storage media for execution by at least one of the one or more computer processors, the program instructions comprising:
program instructions to receive persona data based on user experience to be modeled;
program instructions to receive interview data associated with research candidates;
program instructions to identify one or more target candidates based on a match between the persona data and the interview data;
program instructions to monitor the one or more target candidates for the match during an interview;
program instructions to generate an insight with data synthesis identifying an experience level of the one or more target candidates; and
program instructions to determine a need of additional recruitment based on the insight and the persona data.

16. The computer system of claim 15, wherein program instructions to identify the one or more target candidates comprise:
program instructions to construct a persona input profile based on an input from the interview data;
program instructions to generate a recommended persona covering a key data point; and
program instructions to identify a coverage gap between the persona data and the interview data.

17. The computer system of claim 15, further comprising:
program instructions, stored on the one or more computer-readable storage media, to synthesize research data inputs through cognitive analysis; and
program instructions, stored on the one or more computer-readable storage media, to extract common themes to determine and validate a right pool of interviewees has been identified.

18. The computer system of claim 15, wherein program instructions to generate the insight comprise:
program instructions to apply a natural language processing to cover personas from the persona data based on conversations;
program instructions to use sentiment analysis to cover if the research candidates are engaged; and
program instructions to determine through a natural language processing consistency of answers by individual research candidates.

19. The computer system of claim 15, wherein program instructions to determine the need of additional recruitment comprises:
program instructions to supplement a first interviewee list based on non-covered personas from the persona data; and
program instructions to supplement a second interviewee list based on interviewees of covered personas from the persona data with a low confidence level.

20. The computer system of claim 15, wherein the interview data comprises interview screening criteria, research candidate resumes, and recorded interviews with the research candidates.
